(19) United States
(12) Patent Application Publication
(10) Pub. No.: US 2005/0103887 A1
(43) Pub. Date: May 19, 2005

(54) Sprinkler with nozzle for uniform fluid distribution

(75) Inventor: Chad McCormick, Riverside, CA (US)

Correspondence Address: INSKEEP INTELLECTUAL PROPERTY GROUP, INC, 1225 W. 190TH STREET, SUITE 205, GARDENA, CA, 90248, US

(73) Assignee: The Toro Company

(21) Appl. No.: 10/713,334

(22) Filed: Nov. 14, 2003

(51) Int. Cl. B05B 3/00

(52) U.S. Cl. 239/225.1

(57) ABSTRACT

An improved sprinkler nozzle for both above-the ground and pop-up rotary sprinkler systems that controls precipitation rate and water distribution is disclosed. To apply water in a uniform pattern and provide even coverage and distribution of water, one or more steps are included on the internal wall of the nozzle. These steps, together with a decreasing internal diameter toward the fluid outlet end of the nozzle, increase the boundary layer size of fluid within the flow passage of the nozzle and produce a spray pattern that is uniformly distributed over the entire throw radius of the sprinkler. In addition, one or more wedge-shaped fins may also be included within the internal passage of the nozzle to reduce water turbulence and provide increased fluid flow control and uniform water coverage.

### BACKGROUND OF THE INVENTION

Irrigation sprinkler systems provide a convenient and efficient way of delivering controlled amounts of water to a variety of commercial and residential applications. Such systems typically include a plurality of valves and sprinkler heads in fluid communication with a water source, and a centralized controller connected to the water valves. At appropriate times the controller opens the normally closed valves to allow water to flow from the water source to the sprinkler heads. Water then issues from the sprinkler heads in a predetermined fashion at a set precipitation rate. As used herein, precipitation rate is the amount of water the sprinkler throws onto the area it waters, measured in inches per hour.

There are many different types of sprinkler heads used with conventional sprinkler systems, including above-the-ground heads and “pop-up” heads. The typical pop-up sprinkler head includes a stationary body and a “riser” which extends vertically upward, or “pops up,” when water is allowed to flow to the sprinkler. The riser is typically a hollow tube which supports a nozzle at its upper end. When the normally-closed valve associated with a sprinkler opens to allow water to flow to the sprinkler, two things happen: (i) water pressure pushes against the riser to move it from its retracted to its fully extended position, and (ii) water flows axially upward through the riser. The nozzle then receives the axial flow from the riser and turns it radially to create a radial stream. A spring or other type of resilient element interposed between the body and the riser continuously urges the riser toward its retracted, subsurface position so that when water pressure is removed, the extended riser will immediately proceed to its retracted position.

The riser of a pop-up or above-the-ground sprinkler head can remain rotationally stationary or can include a portion that rotates in continuous or oscillatory fashion to water a circular or partially circular area, respectively. More specifically, the riser of the typical rotary sprinkler includes a first portion that does not rotate and a second portion that rotates relative to the first (non-rotating) portion.

The rotating portion of a rotary sprinkler riser typically carries a nozzle at its uppermost end. The nozzle is set in one side of the sprinkler and is usually inclined upwardly relative to the surface to be watered. Thus, as the sprinkler rotates about a vertical axis, the water stream is thrown outwardly to one side of the sprinkler and travels or sweeps over the ground to water an arc segment determined by the angular extent of the sprinkler's rotation.

One drawback with this type of sprinkler nozzle is uneven coverage and distribution of water. Typically, if water is thrown in a coherent stream at some trajectory relative to the surface to be watered, the stream will tend to water a doughnut shaped ring around the sprinkler with little water being deposited close to the sprinkler. This is obviously a disadvantage since the vegetation closest to the sprinkler will be under-watered. One way of compensating for this could be to increase the length of time the sprinkler is allowed to run. However, increasing water usage to ensure proper watering of vegetation closest to the sprinkler also means that vegetation farther away from the sprinkler (i.e., in the outer radial portions of the watering pattern) will then be over-watered.

Another drawback associated with conventional sprinkler nozzle designs involves water turbulence. For example, as water flows through the fluid passageway of a nozzle, it impacts against the walls or surfaces of the passageway. Water flowing through the passageway and impacting against the surface often changes the stream of water exiting the nozzle from a substantially droplet form into a spray or mist form. As such, water thrown in a spray or mist form is easily blown by the wind and, thereby, produces inaccurate and uneven irrigation of the target area.

To compensate for uneven water distribution, sprinkler systems must be arranged so that the spray patterns of each sprinkler overlap with one another. Known in the industry as head-to-head coverage or head-to-head spacing, this type of sprinkler set-up ensures one hundred percent overlap of watered areas to produce uniform water application. However, this arrangement tends to be rather costly and labor intensive at initial set-up due to the quantity of sprinkler heads and accessory components required. Further, as with any system, the greater the number of components, the greater the cost to maintain such a system.

In view of the above, there is a need for an improved sprinkler nozzle for both above-the ground and pop-up rotary sprinkler systems. In particular, it is desirable that the nozzle applies water in a uniform pattern that provides even coverage and distribution of water. In addition, the nozzle should also be configured to include a broad throw pattern with even water distribution over the entire area. Furthermore, it is desirable that the nozzle reduce water turbulence in order to deliver optimum water-efficient coverage over the irrigation surface.

### BRIEF SUMMARY OF THE INVENTION

In view of the foregoing, it is an object of the present invention to provide an improved sprinkler nozzle that addresses the aforementioned and other undesirable aspects of prior art sprinkler nozzles.

It is a further object of the present invention to provide a sprinkler nozzle having a consistent and predictable watering pattern and volume.

It is a further object of the present invention to provide a sprinkler nozzle having uniform water distribution that eliminates the need for head-to-head coverage.

It is a further object of the present invention to provide a sprinkler nozzle that is durable and cost-effective.

These and other objects not specifically enumerated here are addressed by the present invention which, in at least one embodiment, may include an irrigation sprinkler for uniformly watering a target area comprising a sprinkler body and a nozzle disposed on the sprinkler body. The nozzle includes a substantially hollow, cylindrically shaped body having a first end, a second end and a flow passageway extending therebetween surrounded by an internal wall. In addition, the nozzle further includes a plurality of stepped, radial offsets formed along the internal wall such that an internal diameter of the nozzle decreases from the first end to the second end of the nozzle.

The present invention also contemplates an irrigation sprinkler for uniformly watering a target area comprising a sprinkler body and a nozzle disposed on the sprinkler body. The nozzle includes a substantially hollow, cylindrically shaped body having a first end, a second end and a flow passageway extending therebetween surrounded by an internal wall. In addition, a plurality of stepped, radial offsets are formed along the internal wall such that an internal diameter of the nozzle decreases from the first end to the second end of the nozzle. The sprinkler may further include at least one fin formed along the internal wall to reduce fluid turbulence.

The present invention also contemplates method of uniformly watering a target area, wherein the method comprises providing a sprinkler attached to a fluid source and introducing fluid from the fluid source to the sprinkler. The method further includes urging the fluid to an exit of the sprinkler and increasing a boundary layer thickness of the fluid as it exits the sprinkler by urging the fluid through a stepped internal surface along the exit.

### BRIEF DESCRIPTION OF THE DRAWINGS

Other features and advantages of the present invention will be seen as the following description of particular embodiments progresses in conjunction with the drawings, in which:

FIG. 1 illustrates a partial perspective view of an embodiment of a sprinkler system in accordance with the present invention;

FIG. 2 illustrates an embodiment of a nozzle assembly in accordance with the present invention;

FIG. 3 illustrates a sectional view of the nozzle assembly shown in FIG. 2 in accordance with the present invention;

FIG. 4 illustrates a sectional view of an embodiment of a nozzle in accordance with the present invention;

FIG. 5 illustrates a top, perspective view of an embodiment of a nozzle in accordance with the present invention;

FIG. 6 illustrates a perspective view of an embodiment of a wedge-shaped fin in accordance with the present invention; and

FIG. 7 is a graph illustrating inches per hour of water dropped versus throw radius distance produced by an embodiment of a nozzle in accordance with the present invention.

### DETAILED DESCRIPTION OF THE INVENTION

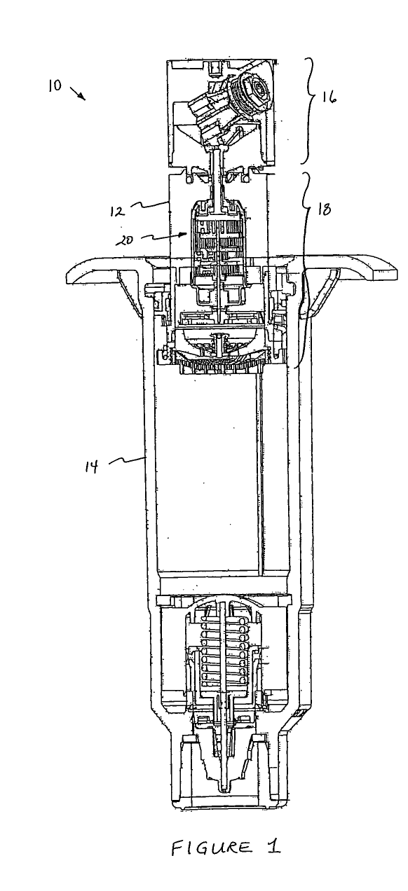

Referring to FIG. 1, an embodiment of a rotary sprinkler system 10 in accordance with the present invention includes a pop-up riser assembly 12 carried within a cylindrical sprinkler body housing 14. In general, the riser assembly 12 includes two major components. The first riser component is a rotatable nozzle assembly 16 and the second riser component is a non-rotatable drive housing 18. Housed within the non-rotatable drive assembly is a rotary drive 20 that rotates the nozzle assembly 16 about a vertical axis of the sprinkler 10. As such, the spray exiting from the nozzle assembly 16 waters a circular pattern during nozzle rotation. Although the following description is made with reference to rotating, pop-up type sprinklers, the invention is not limited thereto and can be used with any conventional rotating or fixed sprinkler designs.

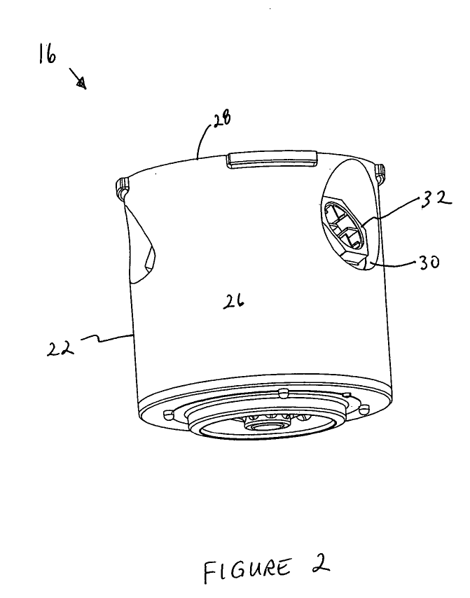

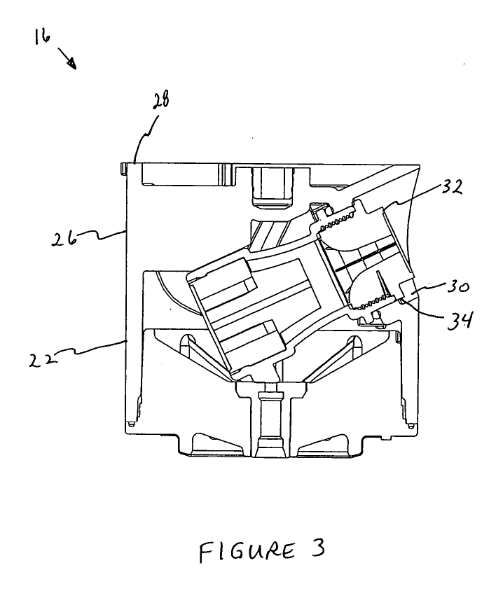

As shown in FIGS. 2 and 3, the nozzle assembly 16 of the sprinkler system 10 includes a nozzle housing 22 having a generally cylindrical form. The nozzle housing 22 may be fabricated from a variety of non-corrosive materials including, but not limited to, polyvinyl chloride (PVC), polyethylene, polybutylene, copper, stainless steel, Acrylonitrile Butadiene Styrene (ABS), acetal (Delrin), polycarbonate and polypropylene. In general, water passes up through the drive housing (not shown), into the interior of the nozzle housing 22 and then exits the nozzle housing 22 in a stream like fashion forming a broad throw pattern over the area to be irrigated, as described in further detail below.

The nozzle housing 22 of the nozzle assembly 16 typically includes a cylindrical sidewall 26 and a top wall 28 fixedly secured thereto. Formed within the sidewall 26 of the nozzle housing 22 is a cavity or seat 30 configured to receive a nozzle 32 for throwing a stream of water to one side of the nozzle assembly 16.

In general, the nozzle 32 of the sprinkler system 10 may be formed as an integral portion of the sidewall 26 of the nozzle assembly or fabricated as a separate component. When formed as a separate component, the external surface 34 of the nozzle 32 is configured to have a mating shape with the seat 30 of the nozzle assembly 16 and may be either permanently or removably installed therein. Typically, it is preferred that the nozzle 32 be removable from the nozzle assembly 16 to allow for cleaning and/or replacement. A variety of mechanisms may be used to permanently or removably attach the nozzle 32 to the nozzle assembly 16. Examples of these mechanisms include, but are not limited to, snap-fit, press-fit, threaded, and adhesives.

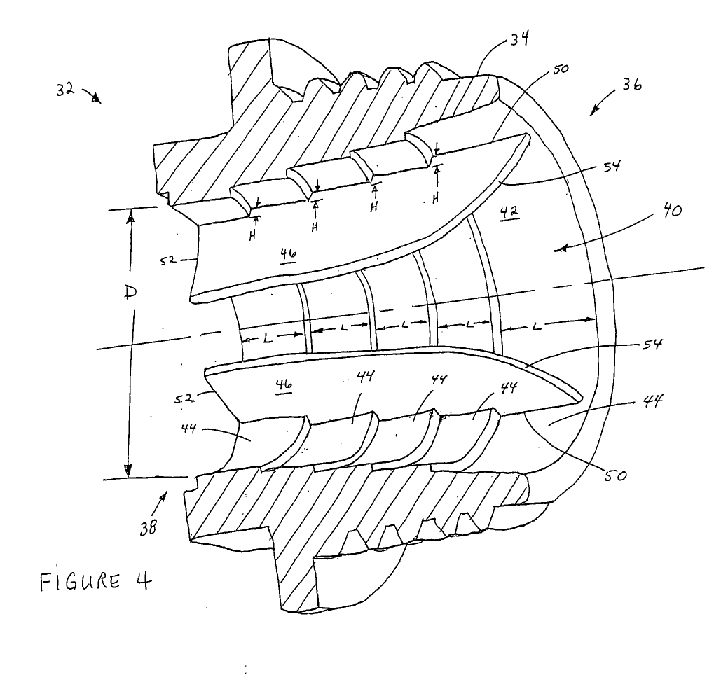

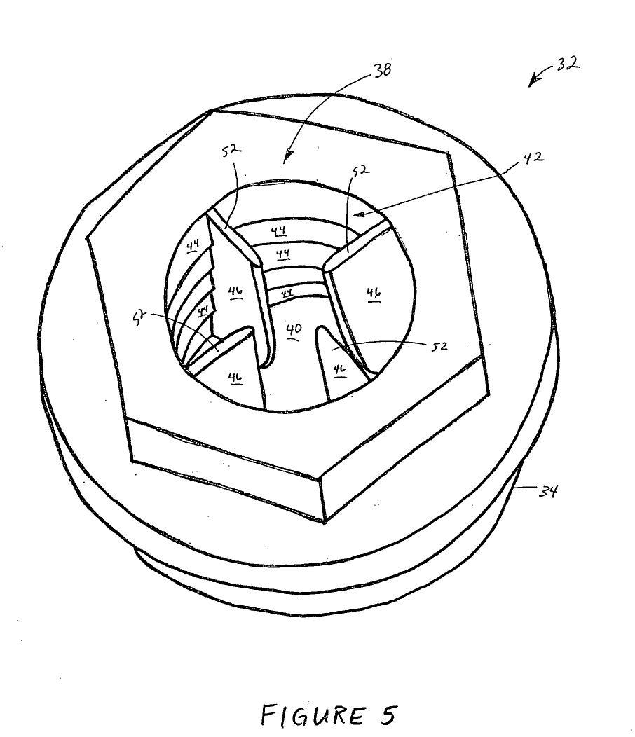

Referring to FIGS. 4 and 5, an embodiment of the nozzle 32 in accordance with the present invention includes a substantially hollow, cylindrically shaped body having a first end 36, a second end 38 and an internal passageway 40 extending therebetween. During use, pressurized water from a water source (not shown) enters the first end or fluid inlet 36 of the nozzle 32, flows through the passageway 40 and then exits the second end or outlet 38 of the nozzle 32. As such, water exits the nozzle 32 in the form of a water stream projected from one side of the nozzle assembly 16.

As shown in FIG. 4, the internal wall 44 that surrounds or forms the flow passage 40 of the nozzle 32 includes one or more stepped, radial offsets 44 formed along the axis of the nozzle 32. In one embodiment, each radial offset 44 is approximately 0.150 inches in length L (wherein length L is measured along the longitudinal axis of the nozzle 32) and approximately 0.020 inches in height H (wherein height H is measured along an axis that is relatively perpendicular to the internal wall 42 of the nozzle 32). Further, these offsets 44 are arranged to reduce the internal diameter D of the nozzle 32 from the fluid inlet end 36 toward the fluid outlet end 38 of the nozzle 32 in a step-wise manner. As a result, the internal diameter D of the fluid inlet end 36 is greater than the internal diameter D of the fluid outlet end 38 of the nozzle 32. For example, in one embodiment, the internal diameter D of the fluid inlet end 36 of the nozzle 32 is approximately within the range of 0.540±0.005 inches and the internal diameter D of the fluid outlet end 38 of the nozzle 32 is approximately within the range of 0.505 inches or less.

In general, this configuration of a stepped flow path influences water flow through the nozzle 32 by increasing the boundary layer size, as explained in further detail below. However, additional nozzle designs may also be used to obtain a desired boundary layer size, spray pattern and precipitation rate. For example, the stepped internal surface 42 of the above-described embodiment may be reversed such that the internal diameter D of the fluid inlet end 36 is less than the internal diameter D of the fluid outlet end 38 of the nozzle 32.

In addition, one or more of the surfaces forming each offset or step 44 may be arranged at various angles to either increase or decrease the boundary layer of fluid within the nozzle 32. For example, steps 44 formed at ninety-degree angles along the internal wall 42 of the nozzle 32 produce a boundary layer size that is greater than the boundary layer size produced by steps 44 formed at forty-five degree angles.

In another embodiment, the steps 44 may be rounded or curved along the internal wall 42 in order to reduce water turbulence. In yet another embodiment, the steps 44 may be configured so that the internal diameter D is variable along the overall length of the nozzle 32. Additional nozzle designs though not specifically described herein but known to those skilled in the art are also included within the scope of the claimed invention.

As referenced above and used throughout this application, the term boundary layer means that portion of water that flows in a layer immediately adjacent the walls or surfaces that form the fluid passageway and confine fluid flow. Thus, for water flowing in a circular pipe or nozzle passage, the boundary layer portion of the water consists of an annular layer of water immediately adjacent the internal wall of the nozzle. Likewise, the non-boundary layer portion of water comprises the rest of the water stream radially inside of the annular boundary layer.

The increase in boundary layer size, produced by the nozzle design illustrated in FIGS. 4 and 5, reduces the speed of fluid flow on the outer portion (i.e., annular, boundary layer) of the water stream (not shown). However, the stepped internal surface 42 of the nozzle 32 has little to no effect on the non-boundary layer portion of the water stream, such that the speed of fluid flow on the inner portion of the water stream remains relatively constant. With the centerline velocity of the fluid flow remaining relatively constant, the nozzle 32 is able to discharge a stream of water with a maximum throw radius extending outwardly from the sprinkler 10 to the target area. Further, because the rate of boundary layer fluid flow is less than centerline velocity, the resulting spray pattern produces even water distribution over the entire throw radius, as described in further detail below.

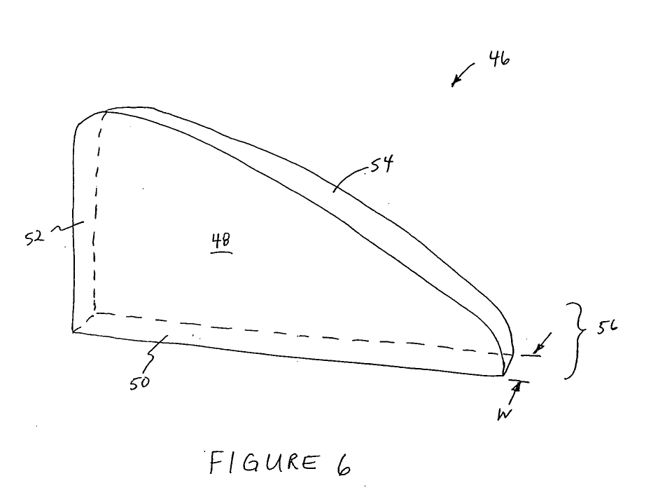

In an alternate embodiment of the invention, one or more stream straightening fins 46 are formed within the stepped flow passage 40 of the nozzle 32. Referring to FIG. 6, each wedge-shaped fin 46 generally comprises two planar surfaces 48 surrounded by three side-surfaces 50, 52, 54 that are perpendicularly aligned with each planar surface 48. Of the three side-surfaces 50, 52, 54, two of the side-surfaces 50, 52 are relatively linearly shaped and one side-surface 54 is slightly curved. Each side-surface 50, 52, 54 forms an angle of a maximum of ninety-degrees with its adjacent side-surface.

In one embodiment of the invention, four wedge-shaped fins 46 are formed within the nozzle 32. The lengths of the linear side-surfaces 50, 52 and curved side-surface 54 of each fin 46 are approximately within the range of 0.540±0.005 inches, 0.160 ±0.005 inches and 0.200±0.005 inches, respectively. In addition, the linear side-surfaces are formed at approximately ninety-degree angles relative to one another with the curved side-surface extending therebetween. Further, the overall width of this embodiment of the wedge shaped fin is approximately within the range of 0.020±0.005 inches. As described in further detail below, this particular configuration presents a fluid-dynamic profile that reduces fluid turbulence and, in some instances, increases the throw radius of the sprinkler.

In addition to the above-described embodiment, alternate configurations of the fins 46 may also be used with the nozzle 32 of the present invention. For example, in addition to wedge-shaped, other fin shapes that may be used include, but are not limited to, rectangular, square, oval and sinusoidal. Further, alternate quantities and widths of each fin 46 may also be used with the present invention, including variable widths on individual fins 46. Additional modifications to fin design within the nozzle, not disclosed herein but known to those skilled in the art, are also included within the scope of the claimed invention.

When formed within the nozzle 32, the longer 50 of the two linear side-surfaces 50, 52 of the fin 46 is positioned relatively parallel to fluid flow and contacts the internal wall 42 of the nozzle 32. In particular, as shown in FIGS. 4 and 5, this longer, linear side-surface 50 further includes one or more indentations or steps configured to match the stepped surface 44 of the nozzle's internal wall 42. In addition, the remaining shorter, linear side-surface 52 of the wedge-shaped fin 46, which runs perpendicular to fluid flow, is positioned adjacent the fluid outlet end 38 of the nozzle 32 and the narrow edge 56 of the fin 46 (formed by the longer side surface 50 and curved side surface 54) is positioned adjacent the fluid inlet end 36 of the nozzle 32. As such, water flowing into the nozzle 32 first strikes the low profile, fluid dynamic end of the fin 46, thereby minimizing the potential of water turbulence.

Based upon the above-described arrangement of side-surfaces 50, 52, 54, the related planar surfaces 48 of the wedge-shaped fin 46 are thereby perpendicularly aligned to the internal wall 42 of the nozzle passage 40 and parallel to fluid flow. As a result, the wedge-shaped fins 46 act as guides to channel fluid flow from the nozzle inlet 36 through the flow passage 40 and to the nozzle outlet 38 with little to no adverse effects on the throw radius. Moreover, because of their design, the wedge-shaped fins 46 decrease turbulence in fluid flow both within the nozzle 32 and exiting the nozzle 32, thereby providing increased fluid flow control and uniform water coverage.

Both the nozzle 32 and wedge-shaped fins 46 can be manufactured as separate components assembled together to form the final subassembly. Alternatively, and for economy of manufacturing, the fins may be integrally molded with the nozzle. In this regard, a variety of materials may be used to fabricate the nozzle and wedge-shaped fins. Examples of these materials include, but not limited to, polyvinyl chloride (PVC), polyethylene, polybutylene, copper, stainless steel, acetal (Delrin) and polypropylene. In addition, the materials used to fabricate these components may be rigid, semi-rigid or flexible, depending upon the desired flow characteristics. For example, flexible materials may be chosen for sprinkler systems 10 exhibiting fluctuating fluid pressures as a means of compensating for these variations and maintaining constant precipitation rates and throw radius. Alternate materials and combinations of materials, not disclosed herein but known to those skilled in the art, may also be used to obtain desired flow characteristics and are also included within the scope of the claimed invention.

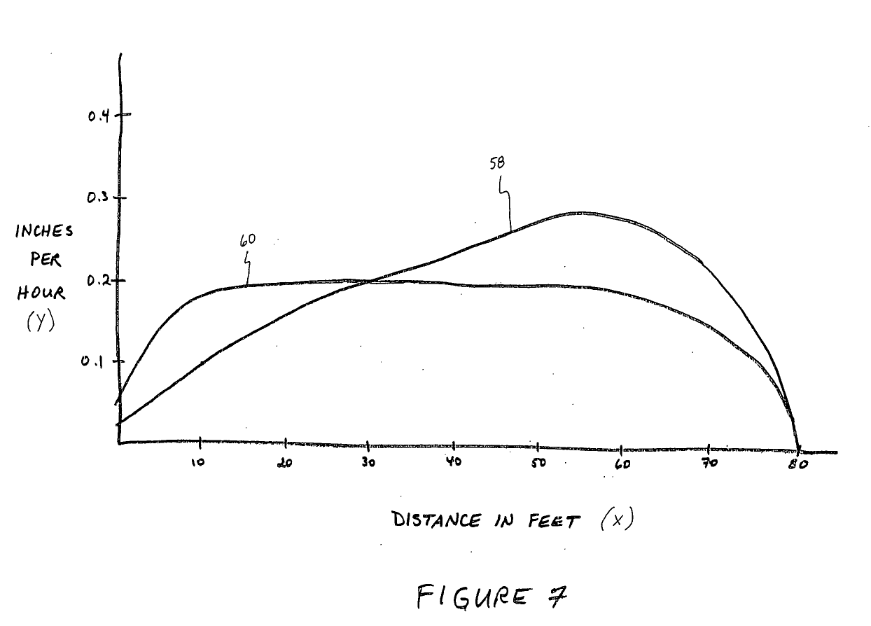

As noted in the Background of the Invention and as set forth above, conventional sprinkler nozzles produce water throw characteristics that result in uneven coverage and distribution of water over the areas to be irrigated. In particular, such nozzles tend to underwater the areas closest to the sprinkler and/or over-water the areas farther away from the sprinkler. As the present invention substantially eliminates these undesirable characteristics, it is instructive to compare the water distribution patterns of conventional nozzles versus those of the nozzle 32 of the present invention. For this purpose, reference is made to FIG. 7.

FIG. 7 depicts an embodiment of water distribution patterns of conventional nozzles 58 versus those of the nozzle of the present invention 60. As shown in FIG. 7, the amount of water dispersed Y over the throw radius X of conventional nozzles 58 gradually increases with increasing throw radius. Conventional nozzles were designed to produce this particular distribution pattern in an attempt to produce uniform water coverage. These designs were based on the idea that because the total area increases with increasing distance from the nozzle, then uniform distribution by area requires more water farther from the nozzle. However, during actual use, areas closest to the sprinkler receive less water than areas farthest away from the sprinkler. As a result, conventional nozzles produce uneven water coverage.

In contrast, the nozzle 32 of the present invention uniformly waters an area that extends from the sprinkler head to the maximum throw radius. In other words, approximately the same amount of water is applied per unit area per unit time over the entire throw radius X of the sprinkler 10.

For example, at a distance of 10 feet, a conventional sprinkler throws an amount of water roughly equivalent to 0.1 inch per hour. At this same distance, the nozzle 32 of the present invention throws an amount of water roughly equivalent to 0.2 inch per hour. Furthermore, at a distance of approximately 55 feet, conventional nozzles generate approximately 0.3 inch per hour, whereas the nozzle 32 of the present invention maintains its precipitation rate at 0.2 inch per hour.

Thus, unlike conventional sprinklers 58, the water 60 dispersed from the nozzle 32 covers the entire target area X in a substantially even manner, including the innermost portions and outermost portions of the area X. As a result, the occurrence of dry spots or over-watered spots within the target area X is reduced or completely eliminated by the nozzle 32 of the present invention.

An additional benefit of the above-described invention pertains to the characteristics of the water stream produced by the nozzle 32. Because the flow passage 40 within the nozzle 32 is configured to reduce water turbulence and other undesirable flow patterns, the stream of water exiting the nozzle 32 is substantially in droplet form. This fluid form not only produces more even coverage and water distribution over the target area but, also, is less susceptible to environmental influences, such as wind.

Furthermore, because of even coverage and distribution of water over the entire irrigation area produced by the nozzle 32 of the present invention, sprinkler systems 10 may no longer need to be arranged with overlapping spray patterns. As such, sprinkler heads can be spaced farther apart from adjacent sprinkler heads without compromising water coverage. This arrangement also provides cost and labor savings both at initial set-up and future maintenance due to the reduced quantity of sprinklers and accessory components required to support such a sprinkler system.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

1. An irrigation sprinkler for uniformly watering a target area comprising:
a sprinkler body;
a nozzle disposed on said sprinkler body;
said nozzle comprising a substantially hollow, cylindrically shaped body having a first end, a second end and a flow passageway extending therebetween surrounded by an internal wall; and
a plurality of stepped, radial offsets formed along said internal wall such that an internal diameter of said nozzle decreases from said first end to said second end of said nozzle.

2. The irrigation sprinkler of claim 1 wherein said nozzle is removable from said sprinkler body.

3. The irrigation sprinkler of claim 1 further including at least one fin formed along said internal wall to reduce fluid turbulence.

4. The irrigation sprinkler of claim 3 wherein said fin is aligned parallel to fluid flow.

5. The irrigation sprinkler of claim 1 wherein said first end is attached to a fluid source.

6. The irrigation sprinkler of claim 1 wherein said second end is attached to a fluid source.

7. The irrigation sprinkler of claim 1 wherein said stepped radial offsets are arranged at various angles to decrease a boundary layer of fluid within said nozzle.

8. An irrigation sprinkler for uniformly watering a target area comprising:
a sprinkler body;
a nozzle disposed on said sprinkler body;
said nozzle comprising a substantially hollow, cylindrically shaped body having a first end, a second end and a flow passageway extending therebetween surrounded by an internal wall;
a plurality of stepped, radial offsets formed along said internal wall such that an internal diameter of said nozzle decreases from said first end to said second end of said nozzle; and
at least one fin formed along said internal wall to reduce fluid turbulence.

9. The irrigation sprinkler of claim 8 wherein said nozzle is removable from said sprinkler body.

10. The irrigation sprinkler of claim 8 wherein said fin is aligned parallel to fluid flow.

11. The irrigation sprinkler of claim 8 wherein said first end is attached to a fluid source.

12. The irrigation sprinkler of claim 8 wherein said second end is attached to a fluid source.

13. The irrigation sprinkler of claim 8 wherein said stepped radial offsets are arranged at various angles to increase a boundary layer of fluid within said nozzle.

14. The irrigation sprinkler of claim 8 wherein said stepped radial offsets are arranged at various angles to decrease a boundary layer of fluid within said nozzle.

15. The irrigation sprinkler of claim wherein said boundary layer flows at a rate less than a centerline fluid velocity.

16. A method of uniformly watering a target area comprising:
providing a sprinkler attached to a fluid source;
introducing fluid from said fluid source to said sprinkler;
urging said fluid to an exit of said sprinkler; and
increasing a boundary layer thickness of said fluid as it exits said sprinkler by urging said fluid through a stepped internal surface along said exit.

17. The method of claim 16 further comprising maximizing a throw radius of said sprinkler by maintaining boundary layer fluid flow at a rate less than centerline velocity.

18. The method of claim 17 further comprising producing even water distribution over said throw radius.

19. The method of claim 16 further comprising providing at least one fin formed along said stepped internal surface to reduce fluid turbulence.

20. The method of claim 19 further comprising providing a nozzle within said exit of said sprinkler to form a water stream projecting from one said of said sprinkler.
